(19) United States
(12) Patent Application Publication
(10) Pub. No.: US 2016/0312772 A1
(43) Pub. Date: Oct. 27, 2016

(54) Dual Gauge Pump Device

(71) Applicant: Louis CHUANG, Taichung (TW)

(72) Inventor: Louis CHUANG, Taichung (TW)

(21) Appl. No.: 15/071,259

(22) Filed: Mar. 16, 2016

(30) Foreign Application Priority Data
Apr. 24, 2015 (TW) 104113293

(51) Int. Cl. F04B 33/00; G01L 19/16; F04B 53/10; F04B 53/14; F04B 39/12; F04B 51/00

(52) U.S. Cl. CPC F04B 33/005; F04B 39/12; F04B 51/00; F04B 53/10; F04B 53/14; G01L 19/16

(57) ABSTRACT

A dual gauge pump device includes a main body including a conduit, an air inlet hole connected to a chamber defined in a pump system, and an air outlet hole. The main body includes a first and second gauge fluidly coupled thereto. A valve system is disposed in a bifurcation of the conduit which extends between the air outlet hole and the second gauge. The valve system includes a sleeve, a shaft, and an elastic member. The sleeve includes a hole interconnecting the conduit and the second gauge. The shaft is engaged with the sleeve and is able to move with respect to the sleeve selectively to a first position in which the hole is closed and to a second position in which the hole is open. The shaft is biased by the elastic member.

### BACKGROUND OF THE INVENTION

1. Field of the Invention

The present invention relates to a pump device and, in particular, to a dual gauge pump device.

2. Description of the Related Art

Taiwan Pat. No. 1460349 shows a gauged pump. The gauged pump includes a pump system and a gauge received by a receiving space defined by a base of the pump system. Furthermore, the gauge is small in size so that the gauged pump can keep compact and easily portable. However, a small sized gauge is not suitable to have a wide operating pressure range, in order to give a user a readable visual indication of operating conditions. Therefore, the gauge is commonly designed with an operating pressure range for bikes which tire pressure is recommended in a range between 40-65 psi, and with another operating pressure range for bikes which tire pressure is recommended in a range between 0-20 psi.

The present invention is, therefore, intended to obviate or at least alleviate the problems encountered in the prior art.

### SUMMARY OF THE INVENTION

According to the present invention, a dual gauge pump device includes a main body including a conduit, an air inlet hole, and an air outlet hole connected with one another. The air inlet hole is connected to and a chamber defined in a pump system which is configured to pump air. A first gauge is fluidly coupled to the main body and includes a first through hole. The conduit includes a first bifurcation connecting to the first through hole. A second gauge fluidly coupled to the main body and includes a second through hole. The conduit includes a second bifurcation connecting to the second through hole. A valve system is disposed in the second bifurcation of the conduit and includes a sleeve, a shaft, and an elastic member. The second bifurcation of the conduit extends between the air outlet hole and the second through hole. The sleeve includes a hole interconnecting the conduit and the second through hole. The shaft is engaged with the sleeve and is able to move with respect to the sleeve selectively to a first position in which the hole is closed and to a second position in which the hole is open, and wherein the shaft is biased by the elastic member.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

It is therefore an objective of the present invention to provide a dual gauge pump device, and the two gauges have different operating pressure ranges.

It is another objective to provide a compact dual gauge pump device.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a dual gauge pump device in accordance with the present invention.

FIG. 2 is a partial, exploded perspective view of the dual gauge pump device of the present invention.

FIG. 3 is a partial, cross-sectional view of the dual gauge pump device of the present invention.

FIG. 4 is another partial, cross-sectional view of the dual gauge pump device of the present invention.

FIG. 5 is a perspective view illustrating the use of the dual gauge pump device to inflate a tire.

FIG. 6 is a partial, enlarged, top view showing a measurement of a pressure made with the two gauges and showing the two gauges subject to a condition in which a valve system of the dual gauge pump device is at a first operating position allowing air flowing into the two gauges.

FIG. 7 is a partial, enlarged, top view showing a measurement of a pressure made with the two gauges and showing the two gauges subject to a condition in which the valve system is at a second operating position preventing more air flowing into and exceeding beyond the pressure range of one of the gauges.

### DETAILED DESCRIPTION OF THE PREFERRED EMBODIMENTS

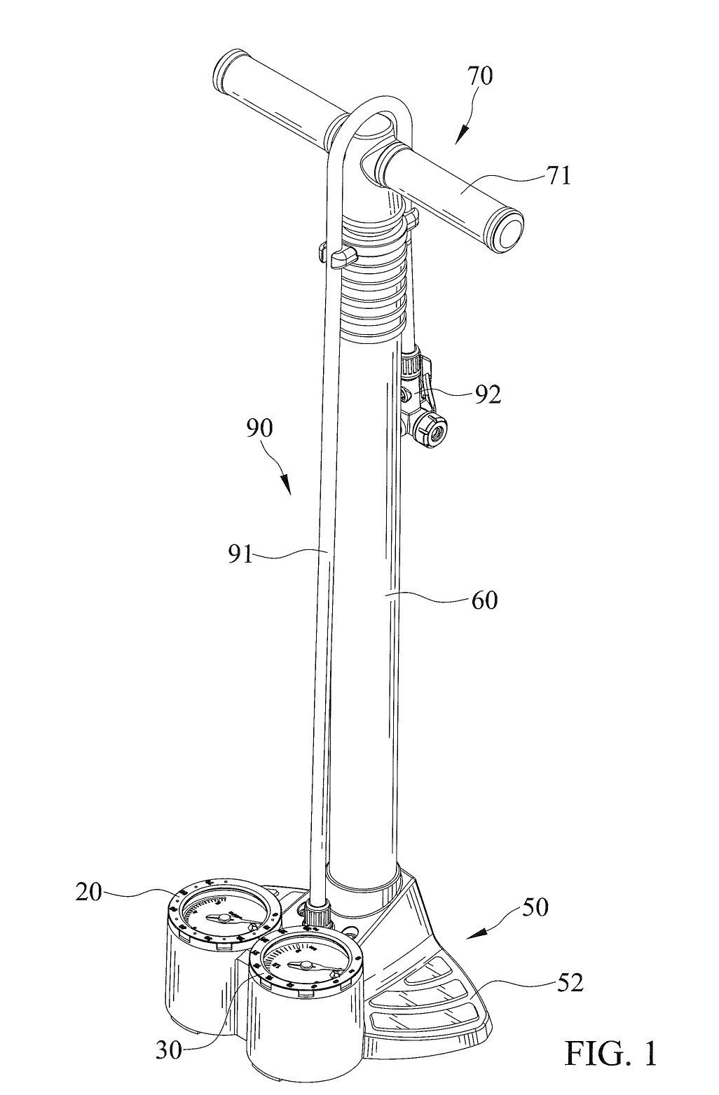

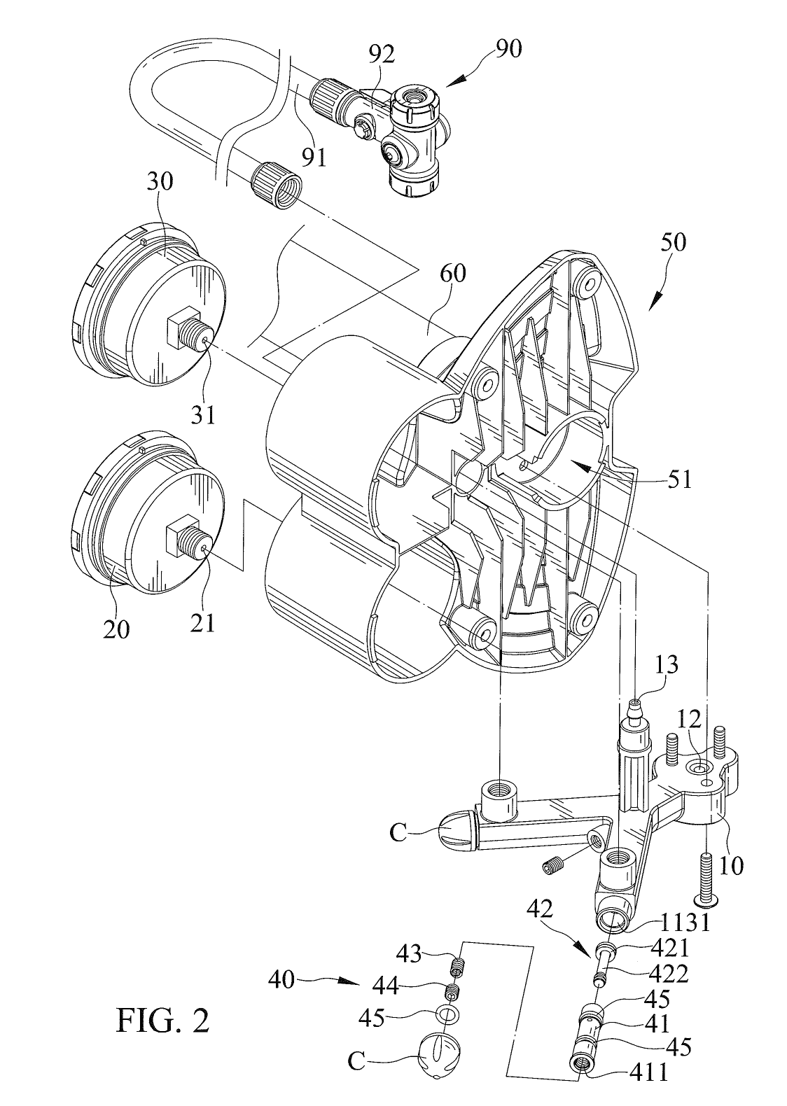

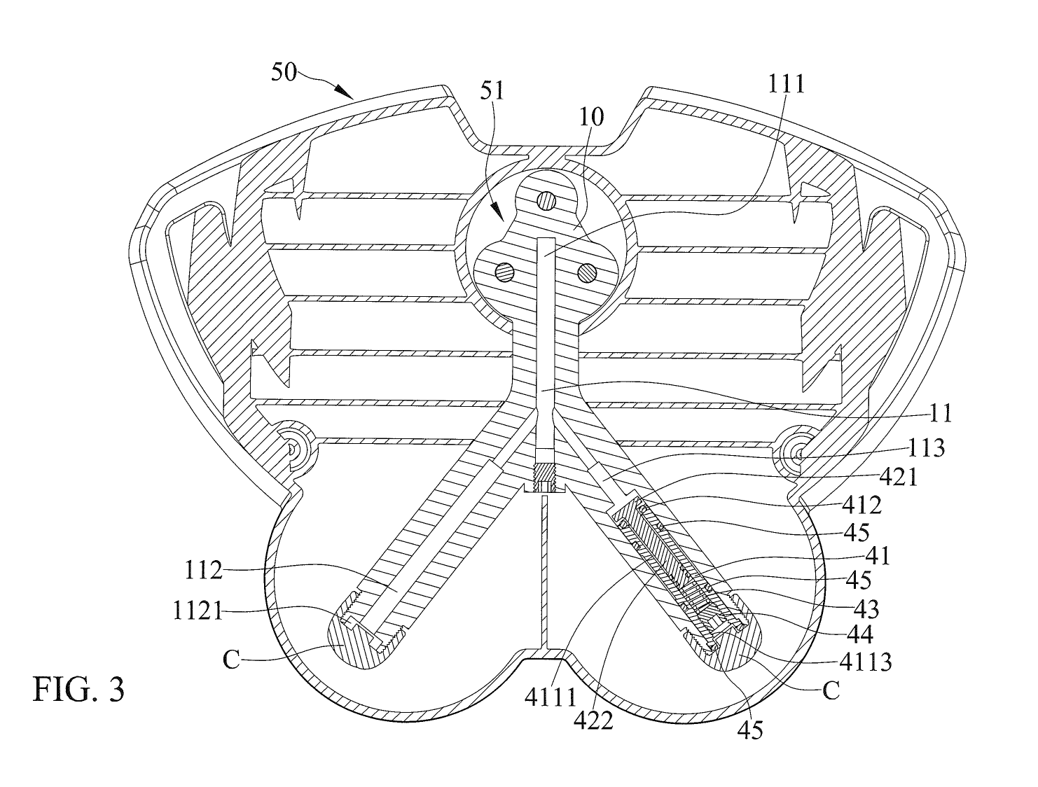

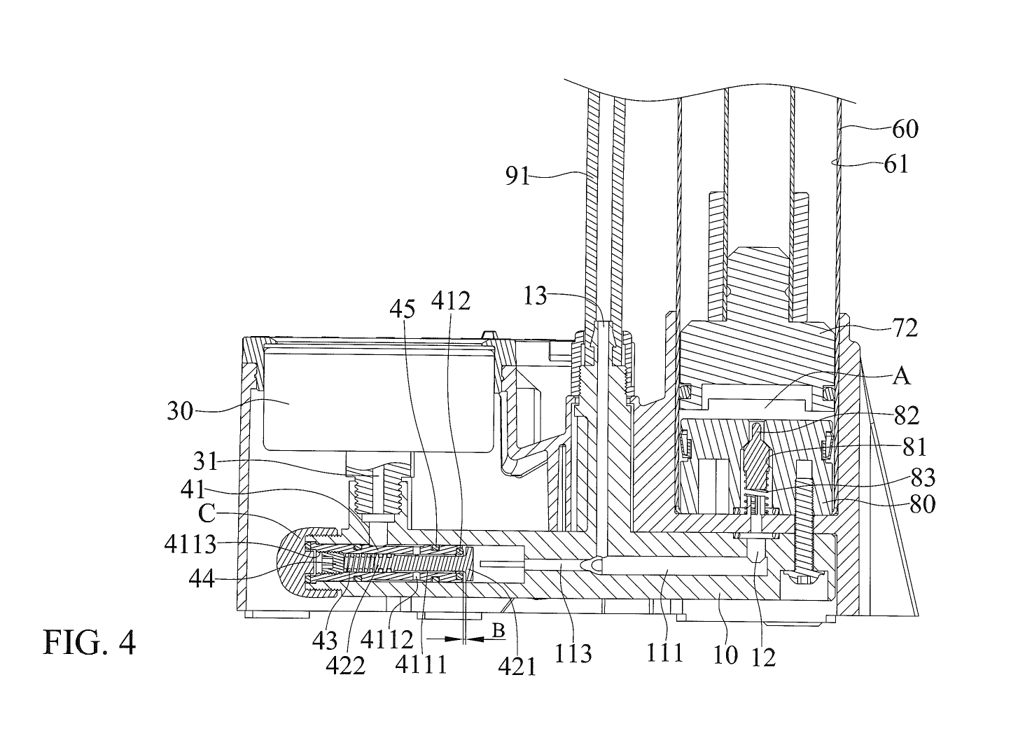

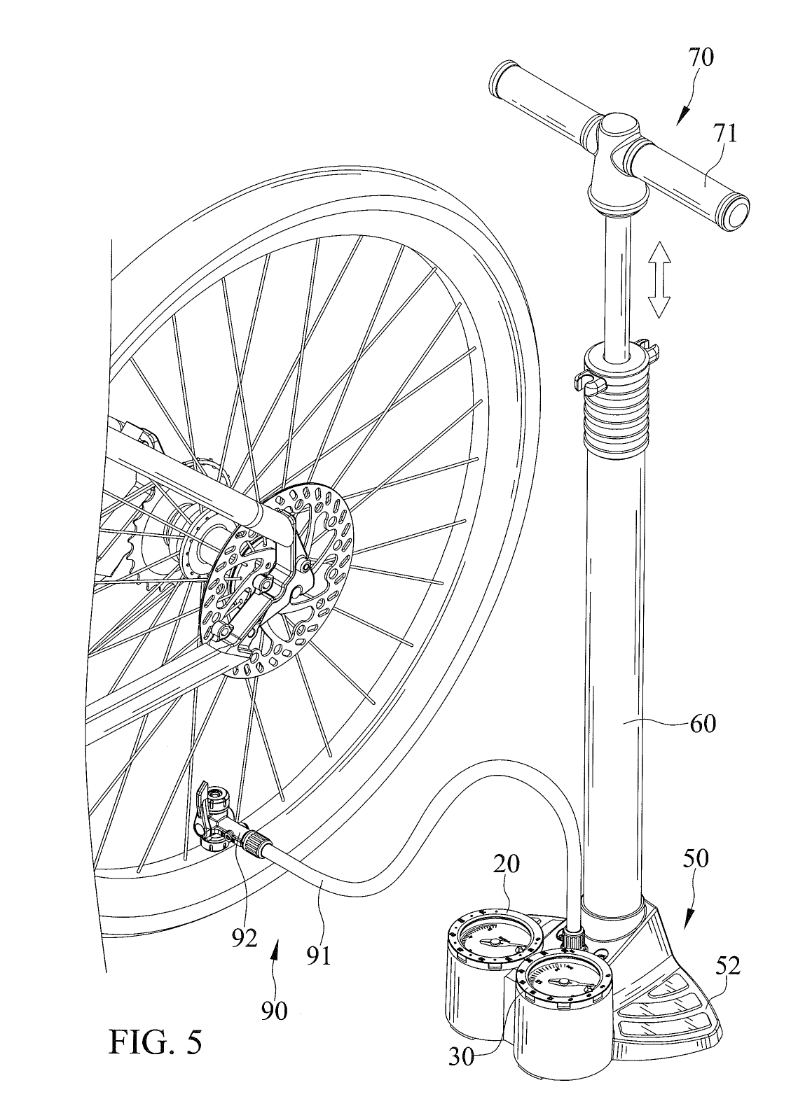

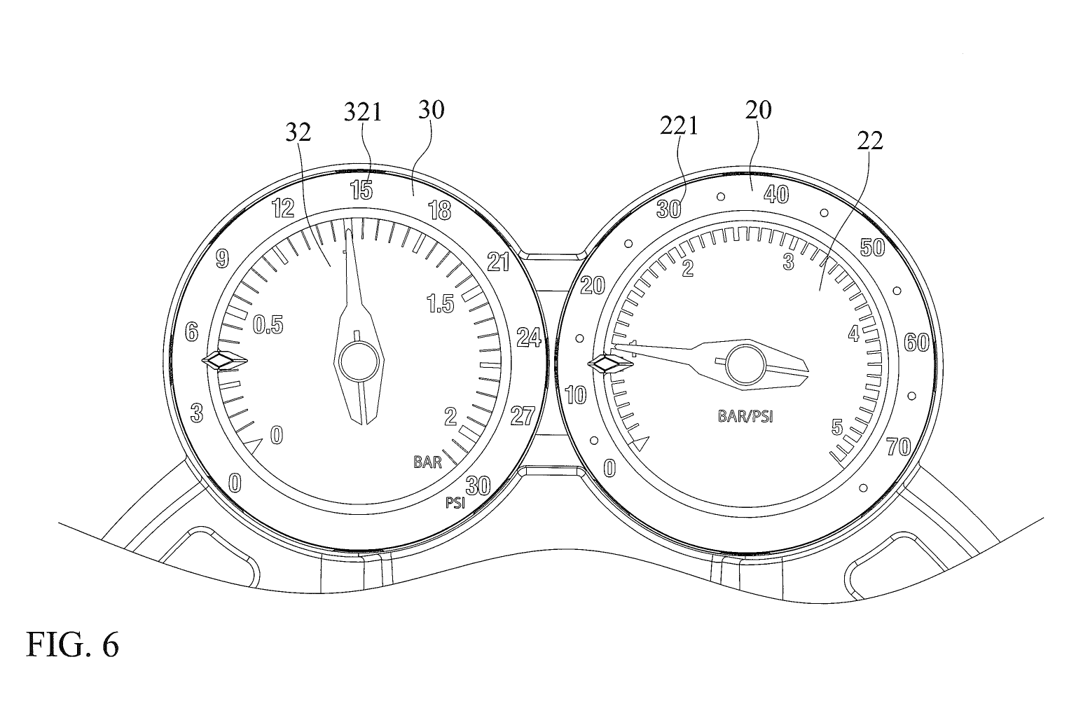

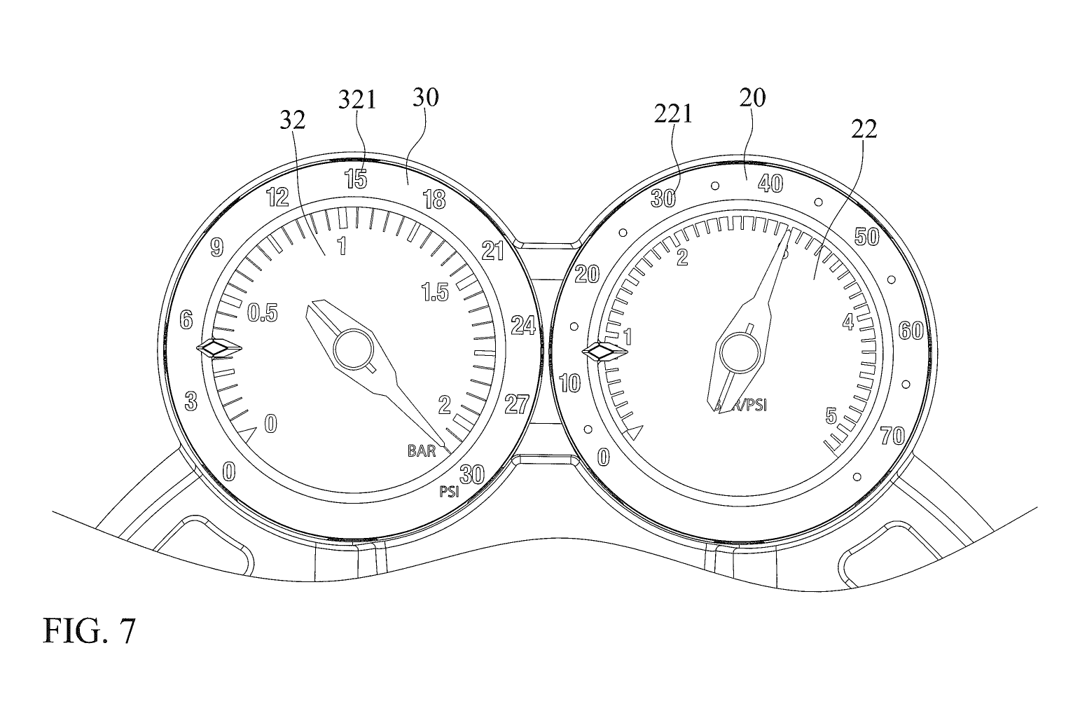

FIGS. 1 through 7 show a dual gauge pump device in accordance with the present invention. A main body 10 includes a conduit 11, an air inlet hole 12, and an air outlet hole 13 connected with one another. The air inlet hole 12 is connected to and a chamber A defined in a pump system which is configured to pump air. Thus, air can flow from the chamber A to the air inlet hole 12, from the air inlet hole 12 to the conduit 11, and from the conduit 11 to the air outlet hole 13. The conduit 11 includes a first section 111 and a second and third section 112 and 113 bifurcating from the first section 111. The conduit 11 includes the second and third sections 112 and 113 thereof intersected such that the conduit 11 is substantially Y-shaped in cross section.

A first gauge 20 is fluidly coupled to the main body 10 and includes a first through hole 21. The first through hole 21 allows entrance of air from the conduit 11. The conduit 11 includes a first bifurcation connecting to the first through hole 21. The first bifurcation is defined by the second section 112 of the conduit 11.

A second gauge 30 is fluidly coupled to the main body 10 and includes a second through hole 31. The second through hole 31 allows entrance of air from the conduit 11. The conduit 11 includes a second bifurcation connecting to the second through hole 31. The second bifurcation is defined by the third section 113 of the conduit 11.

The first and second gauges 20 and 30 have different pressure ranges. The first gauge 20 has a greater pressure range than the second gauge 30 such that a maximum pressure value of the first gauge 20 is bigger than a maximum pressure value of the second gauge 30. The dials 22 and 32 each have dual scales, PSI and BAR. The first gauge 20 has a dial 22 with a pressure range of 0-75 PSI and a scale increment 221 of 5 PSI , as well as a pressure range of 0-5.2 BAR and a scale increment of 0.1 BAR. The second gauge 30 has a dial 32 with a pressure range of 0-30 PSI and a scale increment 321 of 3 PSI, as well as a pressure range of 0-2.1 BAR and a scale increment of 0.05 BAR.

A valve system 40 is disposed in the second bifurcation of the conduit 11 and includes a sleeve 41, a shaft 42, and an elastic member 43. The second bifurcation of the conduit 11 extends between the air outlet hole 13 and the second through hole 31. The sleeve 41 includes a hole 411 interconnecting the conduit 11 and the second through hole 31. The hole 411 defines an opening at an end of the sleeve 41 that adjoins the conduit 11. The hole 411 forms a slide 4111 on which the shaft 42 can move. The slide 4111 extends along a longitudinal length of the sleeve 41. The slide 4111 extends through the sleeve 41. The sleeve 41 includes a port 4112 to which the second through hole 31 is connected. The port 4112 extends radially from the slide 4111. Therefore, air flowed into the slide 4111 can flow into the second through hole 31 through the port 4112. The shaft 42 is biased by the elastic member 43. The elastic member 43 counteracts air charging into the valve system 40 to bias the shaft 42. A soft pad 412 is mounted on the sleeve 41. The soft pad 412 is O-shaped and is of a diametrical size not smaller than that of the rod structure 422. The shaft 42 is engaged with the sleeve 41 and is able to move with respect to the sleeve 41 selectively to a first position in which the hole 411 is closed and to a second position in which the hole 411 is open. When the hole 411 is closed, air is prevented from entering the second gauge 30, and the conduit 11 and the hole 411 are not connected. When the hole 411 is open, the conduit 11 and the hole 411 are connected with each other, and a gap B is formed between the sleeve 41 and the closing structure 421 of the shaft 42. Therefore, air can flow from the conduit 11 to the hole 411 through the gap B. The shaft 42 defines a closing structure 421 selectively closing the opening and abutting the soft pad 412. The shaft 42 disposed at the second position thereof includes the closing structure 421 spaced from the opening and the soft pad 412. The closing structure 421 is disposed outside the sleeve 41. The closing structure 421 has a diametrical size greater than the opening. Therefore, the opening can be closed by the closing structure 421. The diametrical size of the closing structure 421 is also greater than the rod structure 422. In addition, the closing structure 421 has a height smaller than the rod structure 422. Thus, the shaft 42 is T-shaped in cross section. A plug 44 is used as an end stop to restrain an end of the elastic member 43. In addition, another and of the elastic member 43 is restrained by the shaft 42. The plug 44 is releasably disposed in the slide 4111. The hole 411 of the sleeve 41 includes threads 4113. The plug 44 is in thread engagement with the slide 4111, with the plug 44 including threads engaging with the threads 4113 of the hole 411. An outer periphery of the sleeve 41 and a periphery of the third section 113 of the conduit 11 include two O-rings 45 tightly disposed therebetween. Therefore, air only flows from the hole 411 and then the port 4112 to the second through hole 31. The valve system 40 is at a first operating position in which the shaft 42 is disposed at a second position thereof, and is at a second operating position in which the shaft 42 is disposed at a first position thereof. If the maximum pressure of the second gauge 30 is obtained, the valve system 40 will change from the first operating position thereof to the second operating position thereof and the shaft 42 is disposed at the first position thereof.

The main body 10 includes two open ends 1121 and 1131 and the first and second bifurcations of the conduit 11 respectively extend to the two open ends 1121 and 1131. Each of the two open ends 1121 and 1131 is closed by an end cap C and the valve system 40 is restrained in the third section 113 of the conduit 11 by the end cap C engaged therewith. The end caps C are releasably coupled to the main body 10. The end caps C are in thread engagement with the main body 10. The end cap C engaged with the third section 113 of the conduit 11 and an end of the sleeve 41 also include an O-ring 45 tightly disposed therebetween.

The main body 10 is mounted on a base 50. The base 50 includes a space 51 in which the main body 10 and the first and second gauges 20 and 30 are disposed. The base 50 is configured to expose dials 22 and 32 of the first and second gauges 20 and 30 such that the dials of the first and second gauges 20 and 30 are visible in a viewing direction of the first and second gauges 20 and 30. The first and second gauges 20 and 30 are disposed at the same height substantially from the base 50.

The pump system is supported by the base 50 and includes stand areas 52 adapted to be stepped. The base 50 allows the pump system to stand on the ground stably, and a user can hold the pump system down on the ground by placing feet on the base 50. The base 50 includes two stand areas 52 respectively bearing two feet. The pump system includes a cylinder 60 and a plunger 70. The plunger 70 is received by the cylinder 60. The plunger 70 is able to reciprocally move in the chamber A, and therefore, with respect to the cylinder 60. The chamber A is defined by an inner periphery 61 of the cylinder 60. The plunger 70 is adapted to be operably moved by a grip 71. The grip 71 is located outside the cylinder 60 during the operation thereof A piston 72 is disposed in the cylinder 60. The reciprocal movement of the plunger 70 causes the piston 72 to move in the cylinder 60 reciprocally. The piston 72 is configured to push air out of the cylinder 60. A one-way valve system 80 is located between an outlet of the chamber A and the air inlet hole 12 to prevent air discharged from the cylinder 60 from flowing back into the chamber A. The one-way valve system 80 includes a check valve 81 and an elastic element 83 disposed in a channel 82. The chamber A and the air inlet hole 12 are interconnected by the channel 82. The elastic element 83 counteracts air discharged from the chamber A to biases the check valve 81.

The outlet hole 13 is connected to a delivery hose 91. The delivery hose 91 is connected to a valve head 92. The valve head 92 is configured for connecting a valve of an object to be pumped by the dual gauge pump device. Therefore, air discharged from the air outlet hole 13 can flow through the delivery hose 91 and the valve head 92 to the object. The delivery hose 91 and the valve head 92 are grouped as a connecting system 90.

In view of the forgoing, the first and second gauges 20 and 30 are used to make a measurement of a pressure. The valve system 40 is at a first operating position in which the shaft 42 is disposed at a second position thereof and the hole 411 is open, and is at a second operating position in which the shaft 42 is disposed at a first position thereof and the hole 411 is closed. If the maximum pressure of the second gauge 30 is obtained, the valve system 40 will change from the first operating position thereof to the second operating position thereof and the shaft 42 is disposed at the first position thereof.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A dual gauge pump device comprising:
a main body including a conduit, an air inlet hole, and an air outlet hole connected with one another, wherein the air inlet hole is connected to and a chamber defined in a pump system which is configured to pump air;
a first gauge fluidly coupled to the main body and including a first through hole, and wherein the conduit includes a first bifurcation connecting to the first through hole;
a second gauge fluidly coupled to the main body and including a second through hole, and wherein the conduit includes a second bifurcation connecting to the second through hole; and
a valve system disposed in the second bifurcation of the conduit and including a sleeve, a shaft, and an elastic member, wherein the second bifurcation of the conduit extends between the air outlet hole and the second through hole, wherein the sleeve includes a hole interconnecting the conduit and the second through hole, wherein the shaft is engaged with the sleeve and is able to move with respect to the sleeve selectively to a first position in which the hole is closed and to a second position in which the hole is open, and wherein the shaft is biased by the elastic member.

2. The dual gauge pump device as claimed in claim 1, wherein the conduit includes a first section and a second and third section bifurcating from the first section to respectively define the first and second bifurcation of the conduit, and wherein the conduit includes the second and third sections thereof intersected such that the conduit is substantially Y-shaped in cross section.

3. The dual gauge pump device as claimed in claim 1, wherein the hole defines an opening at an end of the sleeve that adjoins the conduit, wherein the shaft defines a closing structure selectively closing the opening, wherein the conduit and the hole are not connected with each other when the opening is closed, and wherein the conduit and the hole are connected with each other when the opening is open and a gap is formed between the sleeve and the closing structure of the shaft.

4. The dual gauge pump device as claimed in claim 1, wherein the main body includes two open ends and the first and second bifurcations of the conduit respectively extend to the two open ends, wherein each of the two open ends is closed by an end cap and the valve system is restrained in the third section of the conduit by the end cap engaged therewith, and wherein the end caps are releasably coupled to the main body.

5. The dual gauge pump device as claimed in claim 1, wherein the hole forms a slide on which the shaft moves, wherein the sleeve includes a port to which the second through hole is connected, wherein the port extends radially from the slide, and wherein an outer periphery of the sleeve and a periphery of the third section of the conduit include two O-rings tightly disposed therebetween.

6. The dual gauge pump device as claimed in claim 1, wherein the first and second gauges have different pressure ranges, and wherein the first gauge has a greater pressure range than the second gauge such that a maximum pressure value of the first gauge is bigger than a maximum pressure value of the second gauge.

7. The dual gauge pump device as claimed in claim 6, wherein the main body is mounted on a base, wherein the base includes a space in which the main body and the first and second gauges are disposed, wherein the base is configured to expose dials of the first and second gauges such that the dials of the first and second gauges are visible in a viewing direction of the first and second gauges.

8. The dual gauge pump device as claimed in claim 7, wherein the pump system is supported by the base and includes stand areas adapted to be stepped.

9. The dual gauge pump device as claimed in claim 6, wherein the shaft is disposed at the first position thereof when the maximum pressure of the second gauge is obtained.

10. The dual gauge pump device as claimed in claim 7, wherein the first and second gauges are disposed at the same height substantially from the base.

11. The dual gauge pump device as claimed in claim 2, wherein the hole defines an opening at an end of the sleeve that adjoins the conduit, wherein the shaft defines a closing structure selectively closing the opening, wherein the conduit and the hole are not connected with each other when the opening is closed, and wherein the conduit and the hole are connected with each other when the opening is open and a gap is formed between the sleeve and the closing structure of the shaft.

12. The dual gauge pump device as claimed in claim 2, wherein the main body includes two open ends and the first and second bifurcations of the conduit respectively extend to the two open ends, wherein each of the two open ends is closed by an end cap and the valve system is restrained in the third section of the conduit by the end cap engaged therewith, and wherein the end caps are releasably coupled to the main body.

13. The dual gauge pump device as claimed in claim 2, wherein the first and second gauges have different pressure ranges, and wherein the first gauge has a greater pressure range than the second gauge such that a maximum pressure value of the first gauge is bigger than a maximum pressure value of the second gauge.

14. The dual gauge pump device as claimed in claim 3, wherein the first and second gauges have different pressure ranges, and wherein the first gauge has a greater pressure range than the second gauge such that a maximum pressure value of the first gauge is bigger than a maximum pressure value of the second gauge.

15. The dual gauge pump device as claimed in claim 4, wherein the first and second gauges have different pressure ranges, and wherein the first gauge has a greater pressure range than the second gauge such that a maximum pressure value of the first gauge is bigger than a maximum pressure value of the second gauge.

16. The dual gauge pump device as claimed in claim 2, wherein the main body is mounted on a base, wherein the base includes a space in which the main body and the first and second gauges are disposed, wherein the base is configured to expose dials of the first and second gauges such that the dials of the first and second gauges are visible in a viewing direction of the first and second gauges.

17. The dual gauge pump device as claimed in claim 3, wherein the main body is mounted on a base, wherein the base includes a space in which the main body and the first and second gauges are disposed, wherein the base is configured to expose dials of the first and second gauges such that the dials of the first and second gauges are visible in a viewing direction of the first and second gauges.

18. The dual gauge pump device as claimed in claim 4, wherein the main body is mounted on a base, wherein the base includes a space in which the main body and the first and second gauges are disposed, wherein the base is configured to expose dials of the first and second gauges such that the dials of the first and second gauges are visible in a viewing direction of the first and second gauges.

19. The dual gauge pump device as claimed in claim 2, wherein the pump system is supported by the base and includes stand areas adapted to be stepped.

20. The dual gauge pump device as claimed in claim 3, wherein the pump system is supported by the base and includes stand areas adapted to be stepped.
